(19) United States
(12) Patent Application Publication
(10) Pub. No.: US 2024/0269783 A1
(43) Pub. Date: Aug. 15, 2024

(54) WELDING APPARATUS FOR MANUFACTURING SECONDARY BATTERY AND WELDING METHOD USING SAME

(71) Applicant: LG ENERGY SOLUTION, LTD., Seoul (KR)

(72) Inventors: Jin Yeong LEE, Daejeon (KR); Jin Soo LEE, Daejeon (KR); Bu Won SON, Daejeon (KR); Yeong Hun JUNG, Daejeon (KR); Yong Gon LEE, Daejeon (KR); Jeong Ho PARK, Daejeon (KR); Geun Young PARK, Daejeon (KR)

(73) Assignee: LG ENERGY SOLUTION, LTD., Seoul (KR)

(21) Appl. No.: 18/022,023

(22) PCT Filed: Aug. 18, 2021
(86) PCT No.: PCT/KR2021/010942

§ 371 Date: Feb. 17, 2023

(30) Foreign Application Priority Data
Aug. 18, 2020 (KR) 10-2020-0103053

(51) Int. Cl. B23K 37/04; B23K 26/12; B23K 101/36

(52) U.S. Cl. CPC B23K 37/0443; B23K 26/1224; B23K 2101/36

(57) ABSTRACT

The present invention relates to a welding apparatus for manufacturing a secondary battery and a welding method using the same, which are capable of preventing deformation of a product due to a pressure applied in all directions or non-uniform welding due to non-uniform pressing to a cover during a process of sealing and fixing the cover to an opening of a main body casing at the time of manufacturing a secondary battery.

### TECHNICAL FIELD

This application claims priority to and the benefit of Korean Patent Application No. 10-2020-0103053 filed with the Korean Intellectual Property Office on Aug. 18, 2020, the entire contents of which are incorporated herein by reference.

The present invention relates to a welding apparatus for manufacturing a secondary battery and a welding method using the same, which are capable of preventing deformation of a product due to a pressure applied in all directions or non-uniform welding due to non-uniform pressing to a cover during a process of sealing and fixing the cover to an opening of a main body casing at the time of manufacturing a secondary battery.

### BACKGROUND ART

In general, secondary batteries are widely used as power sources for mobile devices such as mobile phones and notebook computers. In particular, a lithium secondary battery is advantageous in that the lithium secondary battery has a high operating voltage and a high energy density for unit weight. Therefore, the demand for the lithium secondary battery gradually increases.

The lithium secondary battery mainly uses lithium-based oxide as a positive electrode active material and a carbon material as a negative electrode active material. Specifically, the secondary batteries are sometimes classified into lithium-ion batteries, lithium-ion polymer batteries, and lithium polymer batteries depending on types of used electrolytes or sometimes classified into cylindrical, angular, and pouch-type batteries depending on external shapes of the batteries.

Recently, the angular battery and the pouch-type battery, which has a width smaller than a length, particularly attract attention in accordance with the miniaturization of the mobile devices. The secondary battery has a plurality of battery cells connected in series or parallel to cope with an increase in required output.

Referring to FIGS. 1 and 2, the battery cell of the angular battery, among the secondary batteries, has an angular main body casing 10 having an accommodation space S that accommodates an electrode assembly 1 including a positive electrode, a negative electrode, and a separator.

Further, a cover 20 is mounted at an upper end of the main body casing 10 by laser welding or the like, and then an electrolyte is injected into the accommodation space S through a liquid injection port 13 provided at one side of the main body casing 10.

Thereafter, the liquid injection port 13 is sealed by a metallic ball or the like, which makes it possible to prevent the electrolyte from leaking to the outside of the main body casing 10.

However, because a thin stainless-steel plate is mainly used for the main body casing 10 and the cover 20, there is concern that a product is deformed when the cover 20 is pressed and fixed to an upper portion of the main body casing 10 by a jig 30 (see FIG. 2) for laser welding on the thin plate.

That is, a center of the cover 20 sometimes swells upward because of a pressure applied in all directions when the cover 20 is pressed and fixed by the jig 30, which causes deformation of a product.

In this case, a separate push structure for pushing a central portion of the cover 20 downward may be applied to prevent the swelling of the cover 20. However, the push structure applied may interfere with a welding unit that performs the welding while moving along a closed curve defined along a rim of the cover 20.

In addition, there is a problem in that non-uniform welding occurs because of non-uniform pressing at the time of fixing a position of the cover 20 for welding.

### DISCLOSURE

### Technical Problem

The present invention has been made in an effort to solve the above-mentioned problems, and an object of the present invention is to provide a welding apparatus for manufacturing a secondary battery and a welding method using the same, which are capable of preventing deformation of a product due to a pressure applied in all directions or non-uniform welding due to non-uniform pressing to a cover during a process of sealing and fixing the cover to an opening of a main body casing at the time of manufacturing a secondary battery.

### Technical Solution

To achieve the above-mentioned object, a welding apparatus for manufacturing a secondary battery according to the present invention, which welds a main body casing having an accommodation space having an opening formed at an upper side thereof and a cover configured to close the opening, may include: a lower jig on which the main body casing is positioned: an upper jig configured to engage with the lower jig and press and fix the cover to the main body casing: a vacuum generating unit configured to form a negative pressure in an accommodation space defined by the main body casing and the cover; and a welding unit configured to weld and seal the main body casing and the cover.

In this case, a seating groove may be provided in the lower jig so that the main body casing is seated in the seating groove, and the upper jig may press and fix downward a rim of the cover placed on an upper surface of the lower jig to close and seal the opening of the main body casing.

In addition, a flange portion may be formed around a rim of the opening of the main body casing, and the flange portion may be disposed on and caught by the upper surface of the lower jig where the lower jig is in contact with the upper jig.

In addition, the upper jig may be installed to be movable upward and downward by an actuator.

In addition, a vacuum hole may be formed in the lower jig and communicate with an electrolyte injection port provided at one side of the main body casing, and the vacuum generating unit may form the negative pressure in the accommodation space, defined by the main body casing and the cover, through the vacuum hole.

In addition, the welding apparatus may further include a gasket interposed between the vacuum hole and the electrolyte injection port and configured to keep the vacuum hole and the electrolyte injection port sealed.

In addition, the welding unit may close and fix the opening by performing welding along the rim of the cover which is in contact with the rim of the opening of the main body casing.

In addition, the welding unit may be configured as a laser welding unit.

A welding method for manufacturing a secondary battery, which uses the welding apparatus for manufacturing a secondary battery, may include: disposing the main body casing accommodating an electrode assembly in a seating groove of the lower jig: disposing the cover on an upper surface of the lower jig to close and seal the opening of the main body casing: moving the upper jig downward to press and fix a rim of the cover to a flange portion formed around a rim of the opening of the main body casing: forming, by the vacuum generating unit, a negative pressure in the accommodation space in the main body casing to prevent the cover from swelling: and performing, by the welding unit, welding along the rim of the cover to close and fix the opening.

### ADVANTAGEOUS EFFECTS

The welding apparatus for manufacturing a secondary battery and the welding method using the same according to the present invention configured as described above may press the entire cover with the uniform pressure by forming, through the vacuum generating unit, the negative pressure in the accommodation space in the main body casing, which accommodates the electrode assembly, during the process of welding and fixing the cover to the opening of the main body casing at the time of manufacturing the secondary battery. Therefore, the welding apparatus and welding method may prevent the deformation of a product due to the pressure applied in all directions or the non-uniform welding due to the non-uniform pressing to the cover.

### DESCRIPTION OF DRAWINGS

FIG. 1 is an exploded perspective view illustrating an assembly structure of a general secondary battery.

FIG. 2 is a schematic cross-sectional side view illustrating a welding apparatus for manufacturing a secondary battery in the related art.

FIG. 3 is a schematic cross-sectional side view illustrating a welding apparatus for manufacturing a secondary battery according to the present invention.

FIG. 4 is a detailed view of part ‘A’ in FIG. 3.

FIGS. 5A to 5C are views illustrating a welding process using the welding apparatus for manufacturing a secondary battery according to the present invention.

FIG. 6 is a view illustrating a result of performing welding by using the welding apparatus for manufacturing a secondary battery in the related art.

FIG. 7 is a view illustrating a result of performing welding by using the welding apparatus for manufacturing a secondary battery according to the present invention.

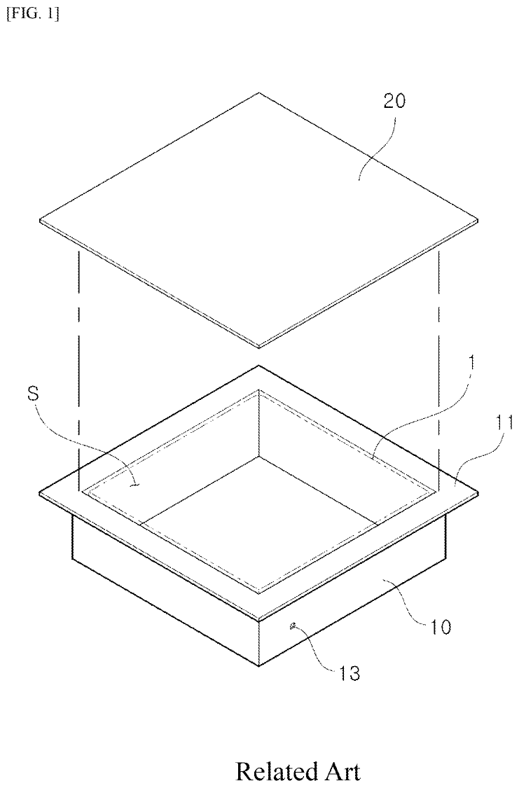

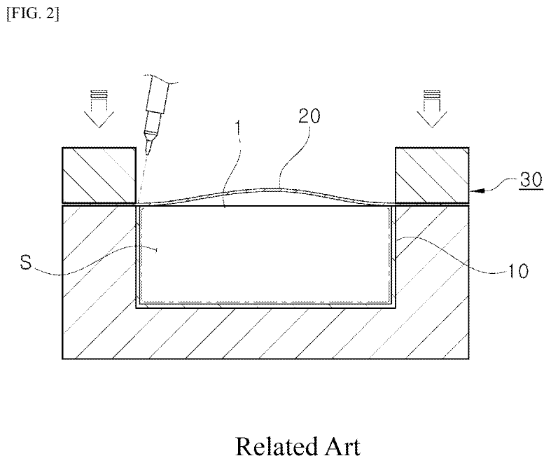

### DESCRIPTION OF MAIN REFERENCE NUMERALS OF DRAWINGS

1: Electrode assembly
10: Main body casing
S: Accommodation space
11: Flange portion
13: Electrolyte injection port
20: Cover
100: Welding apparatus
110: Lower jig
111: Seating groove
113: Vacuum hole
120: Upper jig
130: Vacuum generating unit
131: Vacuum pump
140: Welding unit

### MODE FOR INVENTION

Hereinafter, configurations and operations of specific embodiments of the present invention will be described in detail with reference to the accompanying drawings.

In giving reference numerals to constituent elements of the respective drawings, it should be noted that the same constituent elements will be designated by the same reference numerals, if possible, even though the constituent elements are illustrated in different drawings.

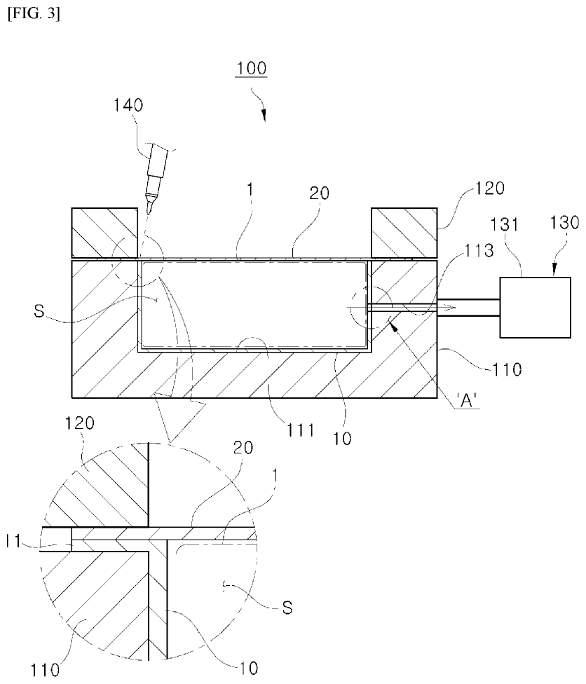

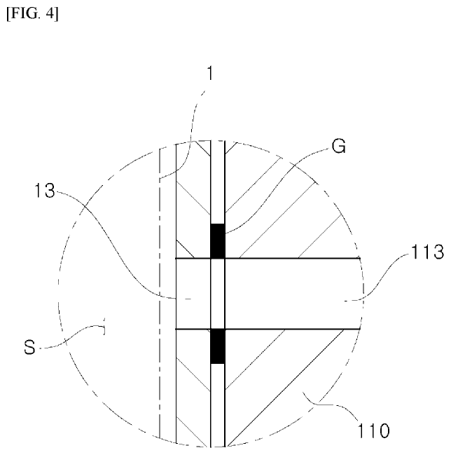

FIG. 3 is a schematic cross-sectional side view illustrating a welding apparatus for manufacturing a secondary battery according to the present invention, and FIG. 4 is a detailed view of part ‘A’ in FIG. 3.

Referring to FIGS. 3 and 4, the present invention serves to weld a main body casing 10 having an accommodation space S having an opening formed at an upper side thereof and a cover 20 for covering the opening. A welding apparatus 100 for manufacturing a secondary battery according to an exemplary embodiment of the present invention may include a lower jig 110, an upper jig 120, a vacuum generating unit 130, and a welding unit 140.

The configuration of the present invention will be specifically described below.

For reference, in the present invention, an example will be illustrated and described in which the main body casing 10 and the cover 20, which are welding targets, have an angular shape such as a tetrahedron. Further, an electrolyte injection port 13 may be provided at one side of the main body casing 10 so that an electrolyte may be injected into the accommodation space.

First, the lower jig 110 defines a main body of the welding apparatus 100 and may have a seating groove 111 on which the main body casing 10, which is the welding target, may be seated. The seating groove 111 may have a shape and size corresponding to those of the main body casing 10.

A vacuum hole 113 may be penetratively formed at one side of the lower jig 110 so that the electrolyte injection port 13 of the main body casing 10 may be connected to the vacuum generating unit 130 to be described below.

Meanwhile, a flange portion 11 may be formed around an opening rim of the main body casing 10. Therefore, the flange portion 11 may be seated by being disposed on and caught by an upper surface of the lower jig 110 where the lower jig 110 and the upper jig 120 to be described below are in contact with each other when the main body casing 10 is seated.

The upper jig 120 may be installed above the lower jig 110 and moved upward or downward by an actuator (not illustrated). The upper jig 120 may press and fix downward the rim of the cover 20 placed on the upper surface of the lower jig 110 to close and seal the opening of the main body casing 10.

The vacuum generating unit 130 may form a negative pressure in the accommodation space S of the main body casing 10 to prevent the cover 20 placed on an upper portion of the main body casing 10 from swelling.

Specifically, the vacuum hole 113 may be formed at one side of the lower jig 110 and communicate with the electrolyte injection port 13 of the main body casing 10. The vacuum generating unit 130 may include a vacuum pump 131 that generates a vacuum in the accommodation space S of the main body casing 10 through the vacuum hole 113. Therefore, the negative pressure may be formed in the accommodation space S.

In this case, a gasket G (see FIG. 4) may be interposed between the vacuum hole 113 and the electrolyte injection port 13 and keep the vacuum hole 113 and the electrolyte injection port 13 sealed. In particular, the gasket G may be integrated with an inner peripheral surface of the seating groove 111 of the lower jig 110.

The welding unit 140 may perform the welding along the rim of the cover 20 being in contact with the opening rim of the main body casing 10, thereby closing and fixing the opening of the main body casing 10. The welding unit 140 may use laser welding. In particular, the laser welding may be performed on a metallic material to ensure processing precision. Of course, the present invention is not limited thereto and may be applied to various materials including metal, and various welding methods may be applied as long as the welding methods may easily weld and fix the main body casing 10 and the cover 20.

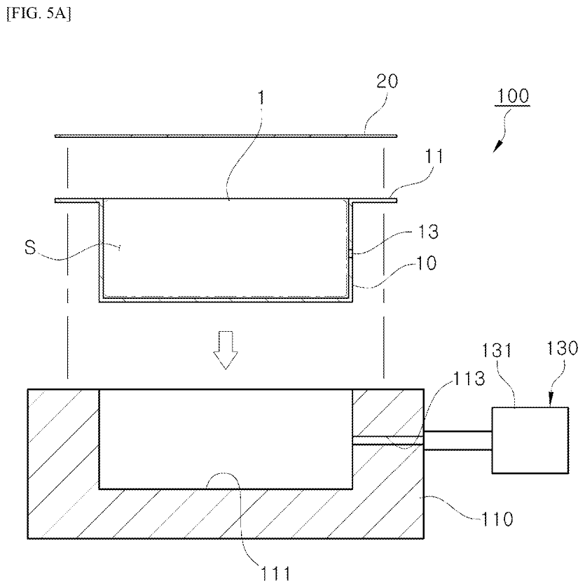

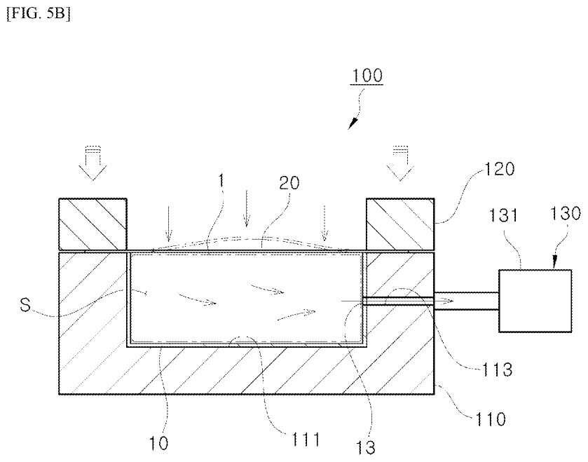

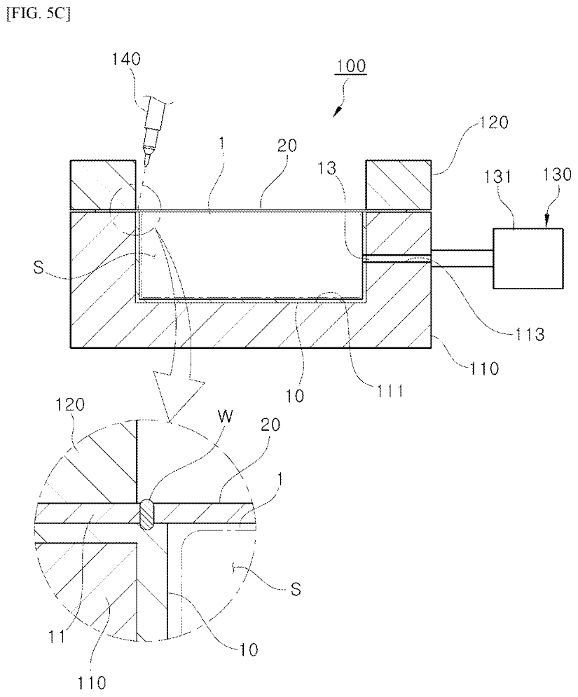

Then, a welding process using the welding apparatus 100 for manufacturing a secondary battery according to the present invention configured as described above will be described with reference to FIGS. 5A to 5C.

Referring to FIG. 5A, the main body casing 10 accommodating an electrode assembly 1 is disposed in the seating groove 111 of the lower jig 110. The main body casing 10 is disposed such that the flange portion 11 provided around the opening rim of the main boding casing 10 is in contact with the upper surface of the lower jig 110. In this case, in the present invention, the example has been described in which the electrode assembly 1 is accommodated in the main body casing 10 first, and then the main body casing 10 is disposed in the seating groove of the lower jig 110. However, the present invention is not limited thereto, and the main body casing 10 may be seated on the lower jig 110 first, and then the electrode assembly 1 may be accommodated in the accommodation space S.

Thereafter, the cover 20 is disposed on the upper surface of the lower jig 110 to close and seal the opening of the main body casing 10 in which the electrode assembly 1 is accommodated. That is, the cover 20 is disposed to be in contact with the flange portion 11 of the main body casing 10.

Then, as illustrated in FIG. 5B, the upper jig 120 is moved downward to press and fix the rim of the cover 20 to the flange portion 11 of the main body casing 10.

When the rim of the cover 20 is in contact with the flange portion 11 of the main body casing 10 by the upper jig 120, the vacuum generating unit 130 forms the negative pressure in the accommodation space S of the main body casing 10. Therefore, the vacuum generating unit 130 may prevent the cover 20 from swelling because of a pressure applied in all directions by the upper jig 120.

In this state, as illustrated in FIG. 5C, the welding unit 140 performs laser welding W along the rim of the cover 20 and close and fix the opening of the main body casing 10.

When the cover 20 is sealed and fixed to the opening of the main body casing 10 by the welding W, the product is withdrawn from the lower jig 110, and then the electrolyte is injected into the accommodation space S in the main body casing 10 through the electrolyte injection port 13 (not illustrated). Thereafter, the electrolyte injection port 13 is sealed by a metallic ball (not illustrated) or the like, which makes it possible to prevent the electrolyte from leaking to the outside of the main body casing 10.

The welding apparatus for manufacturing a secondary battery and the welding method using the same according to the present invention described above may form, through the vacuum generating unit 130, the negative pressure in the accommodation space S in the main body casing 10, which accommodates the electrode assembly 1, at the time of welding and fixing the main body casing 10 and the cover 20 for manufacturing a secondary battery. Therefore, the welding apparatus and welding method may prevent non-uniform welding due to non-uniform pressing or deformation of a welded product due to swelling of the cover caused by a pressure applied in all directions and generated during a process of sealing and fixing the cover 20 to the opening of the main body casing 10. Further, it is possible to ensure processing precision by adjusting a magnitude of the negative pressure generated by the vacuum generating unit 130 depending on materials of the main body casing 10 and the cover 20.

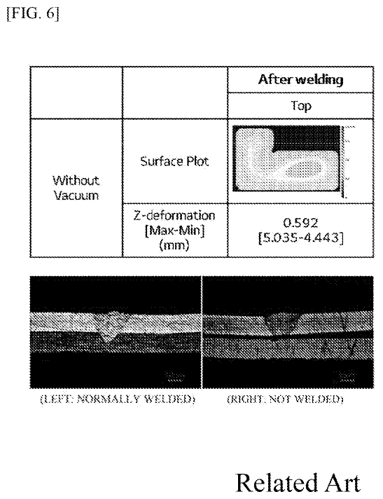

Specifically, as illustrated in FIG. 6, in the case of a welding apparatus in the related art, a central portion of the cover 20 may be swelled and deformed after welding because of a pressure applied in all directions generated at the time of pressing and fixing the cover 20. In addition, non-uniform welding may occur because of non-uniform pressing at the time of fixing the cover 20 for welding.

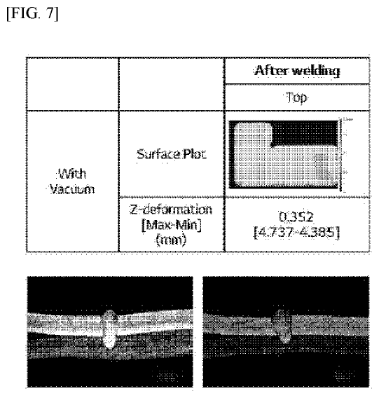

In contrast, according to the present invention, as illustrated in FIG. 7, the vacuum generating unit 130 may form the negative pressure in the main body casing 10, thereby preventing deformation such as swelling of the cover 20. Therefore, it can be ascertained that the uniform welding may be performed on the product without a position deviation.

While the present invention has been illustrated and described with reference to the particular specific embodiments, the present invention is not limited to the embodiments, and various alterations and modifications may be made without departing from the technical spirit of the present invention.

1. A welding apparatus for manufacturing a secondary battery, the secondary battery having a main body having an opening at an upper side thereof and a cover configured to close the opening to define an accommodation space, the welding apparatus comprising:
a lower jig configured to support the main body casing;
an upper jig configured to engage the lower jig to press the cover to the main body casing;
a vacuum generator configured to apply a negative pressure to the accommodation space defined by the main body casing and the cover; and
a welding unit configured to weld the main body casing and the cover.

2. The welding apparatus of claim 1, wherein a seating groove is provided in the lower jig so that the main body casing is seated in the seating groove, and
wherein the upper jig is configured to press a rim of the cover placed on an upper surface of the lower jig to close the opening of the main body casing.

3. The welding apparatus of claim 1, wherein the main body casing includes a flange portion around a rim of the opening of the main body casing, and the flange portion is disposed on an upper surface of the lower jig where the lower jig is in contact with the upper jig.

4. The welding apparatus of claim 1, wherein the upper jig is installed to be-movable upward and downward relative to the lower jig.

5. The welding apparatus of claim 1, wherein a vacuum hole is provided in the lower jig, the vacuum hole being in communication with an electrolyte injection port provided at one side of the main body casing, and the vacuum generator is configured to apply the negative pressure to the accommodation space, defined by the main body casing and the cover, through the vacuum hole.

6. The welding apparatus of claim 5, further comprising:
a gasket interposed between the vacuum hole and the electrolyte injection port, the gasket being configured to seal the vacuum hole and the electrolyte injection port.

7. The welding apparatus of claim 1, wherein the welding unit is configured to weld along a rim of the cover which is in contact with a rim of the opening of the main body casing.

8. The welding apparatus of claim 1, wherein the welding unit is a laser welding unit.

9. A welding method for manufacturing a secondary battery, which uses the welding apparatus for manufacturing the secondary battery according to claim 1, the welding method comprising:
disposing the main body casing in a seating groove of the lower jig;
disposing the cover on an upper surface of the lower jig to close the opening of the main body casing;
moving the upper jig downward to press a rim of the cover to a flange portion around a rim of the opening of the main body casing;
applying, by the vacuum generator, a negative pressure to the accommodation space in the main body casing to prevent the cover from swelling; and
performing, by the welding unit, welding along the rim of the cover to close the opening.

10. The welding method of claim 9, wherein the method further includes placing an electrode assembly in the main body casing prior to disposing the cover on the upper surface of the lower jig to close the opening of the main body casing.

11. The welding method of claim 9, wherein the method further includes placing an electrode assembly in the main body casing prior to disposing the main body casing in the seating groove of the lower jig.

12. The welding method of claim 9, wherein a vacuum hole is provided in the lower jig, the vacuum hole being in communication with an electrolyte injection port provided at one side of the main body casing, and
wherein in applying the negative pressure to the accommodation space in the main body casing, the negative pressure is applied through the vacuum hole and the electrolyte injection port.
